(19) United States
(12) Patent Application Publication
(10) Pub. No.: US 2011/0277702 A1
(43) Pub. Date: Nov. 17, 2011

(54) Disposable Slippers For Animals

(76) Inventor: Peter Taslakian, North Hills, CA (US)

(21) Appl. No.: 12/777,376

(22) Filed: May 11, 2010

(51) Int. Cl. A01K 29/00; B32B 38/00

(52) U.S. Cl. 119/850; 156/242

(57) ABSTRACT

A simple and easy to put on and take off disposable animal slipper design. A bag-like sleeve, cut from a tubular supply, with sealed bottom and open top, is secured on an animal foot with a detached strip or rubber band. The slipper wrapped animal foot is thus protected from dirt and other outdoor conditions. After use the slipper is disposed.

### DESCRIPTION OF RELATED ART

The present application relates to footwear for animals, and more particularly, to disposable slippers for animals that are easy to put on and take off and are economic to manufacture in many different sizes.

Note that the points discussed below may reflect the hindsight gained from the disclosed inventions, and are not necessarily admitted to be prior art.

Due to the need to protect animals from injury and to keep clean during a walk, protective booties, socks, or shoes have been proposed for pets such as dogs in the past. The user simply removes the booties before the animal enters the house. Such footwear is generally non-disposable and must be washed between uses, and is often of a relatively complex and cumbersome nature. For example, U.S. Pat. No. 6,546,704 of Fisher describes a dog boot comprising a planar flexible sheet of material comprising a high friction outer layer, a foam central layer, and a fabric inner layer. The sheet is designed to be wrapped around the leg and foot and snapped together with fastener straps.

Disposable animal booties are also been proposed. US 2007/0700531 A1 describes a pet bootie that is formed by a sleeve of pliable, disposable and liquid impervious material having a closed end for receiving an animal's paw and an open end, and also a loop of elastic material having an inner end secured to the sleeve at a predetermined distance from the open end of the sleeve and projecting outwardly from the sleeve. The loop is of predetermined extended length for allowing the loop to be extended around the sleeve and the animal's leg when the paw is inserted into the closed end of the sleeve, whereby the sleeve is secured in position.

Still manufacturing such animal bootie requires permanently securing the elastic loop to the bootie which increases significantly the manufacturing cost in producing such booties; and for animals of long legs, the length of the loop may not accommodate the requirement of both being tight enough for securing the bootie to the leg and simultaneously being long enough to stretch over the foot to put on. Also the attached elastic loop may be cumbersome for the user to take it off the animal, especially for large animals.

The cost and the cumbersome to use has prevented their commercializing widely.

### SUMMARY

The present application discloses a novel approach to reduce the cost of manufacturing and the need of easy use.

In one embodiment, an animal slipper has two components: a bag like sleeve, with a rectangular or round cornered closed bottom, and an opening top to allow animals leg to slip in to protect paws, hooves and so forth, made of biodegradable and or recyclable materials like poly Uterine and other available material; and a second component, an independent, unattached band with an open end resembling a tape.

In another embodiment, the band may be a closed end elastic band similar to a rubber band, to go around the animals leg on top of the bag like slipper to secure a perfect fit. The band may be made of rubber material or self stick tapes such as Nexcare™ first aid tape without attaching itself to animals hair or skin.

The bag like sleeve may be formed by a mold or cut from tube shape supplies, thus dramatically reducing the cost in manufacturing. The open end securing band can easily surround the animal leg and securing the bag in best fit the animal leg and foot. After being used, the bag shaped sleeve can be easily taken off the animal foot and disposed.

### BRIEF DESCRIPTION OF THE DRAWINGS

The disclosed inventions will be described with reference to the accompanying drawings, which show important sample embodiments of the invention and which are incorporated in the specification hereof by reference, wherein:

FIGS. 1A and 1B schematically show a cross sectional view of an example of the components of animal slipper in accordance with this application.

FIG. 2 shows a cross sectional view of an example of an assembly of the components of animal slipper in accordance with this application.

FIGS. 3A and 3B show cross sectional views of two examples of the animal slipper component in accordance with this application.

FIGS. 4A and 4B show side views of the animal slipper in use without or with a securing band around an animal's paw.

FIG. 5 schematically demonstrates an example process of securing an animal slipper on an animal's paw in accordance with this application.

### DETAILED DESCRIPTION OF SAMPLE EMBODIMENTS

The numerous innovative teachings of the present application will be described with particular reference to presently preferred embodiments (by way of example, and not of limitation). The present application describes several inventions, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements, but may include other elements not expressly listed or inherent to such process, method, article, apparatus, or composition.

Animal owners have long been concerned with the dirty footprints of their animals after an outdoor activity, or the harsh weather conditions and sharp debris found outdoors, especially when their animals have existing injuries. Many different footwear have been designed, however the cost and the cumbersome to use have prevented their commercializing widely.

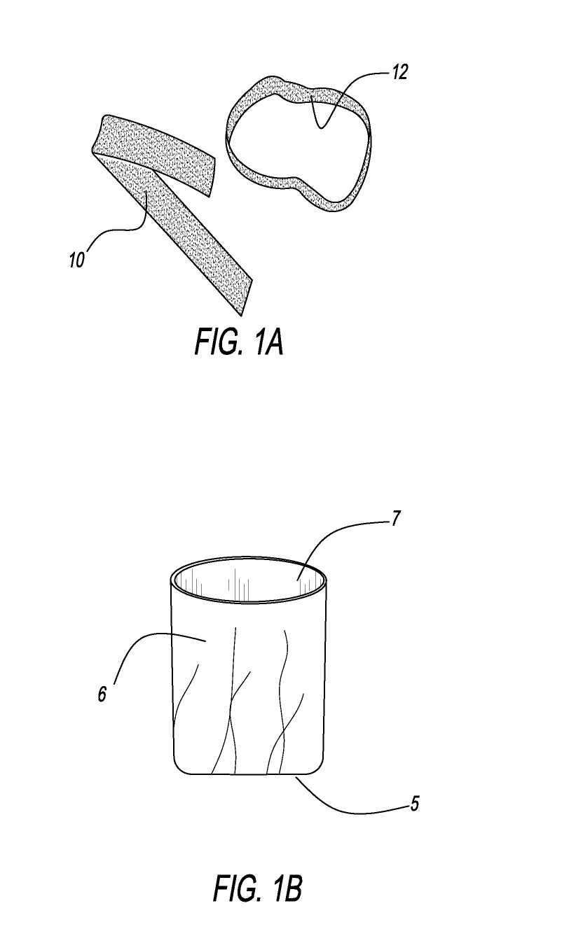

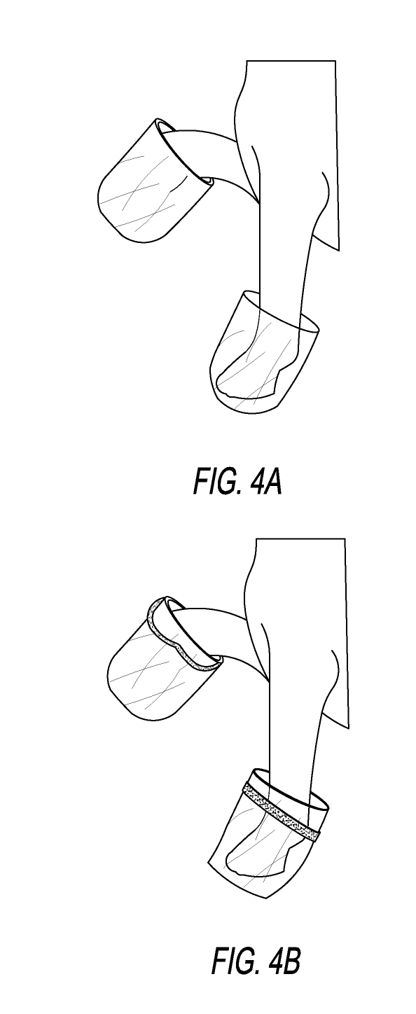

A simple and easy to use and manufacture, disposable animal slipper is thus designed. In reference to FIGS. 1A and 1B, the animal slipper includes two parts, a bag like bootie that has cornered, closed bottom 5, preferably 90 degrees, and top wide opening 7, and a securing detached band or strip 10 or a detached elastic loop 12. The bag-like bootie may have an alternative sticky pad 9 for holding a detached sticky band 10 as shown in FIG. 1A. The opening 7 allows animal's leg to easily slip in and for the sealed bottom 5 to wrap the paw, hooves and so forth (FIG. 4A, 5A).

The bag-like bootie or slipper is made of sufficiently durable, pliable, biodegradable and or recyclable materials, such as, polyuterine. The bag-like slipper can easily be formed by molding or cutting from tubular supply and sealing one end of the opening from the cut. In order to be liable or water proof, multiple layers of material may be used in molding the bag or in forming the tubular supply.

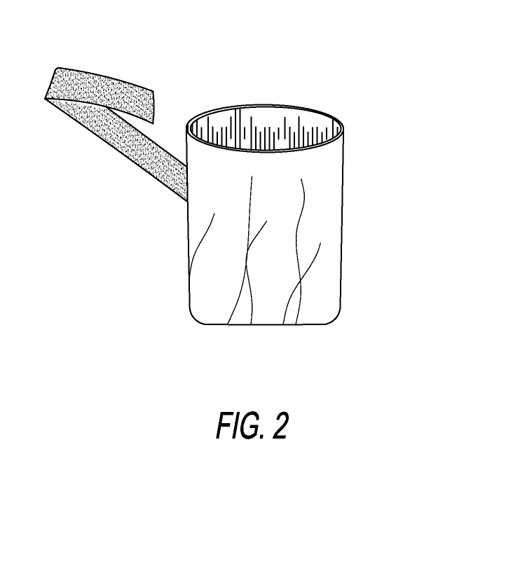

Detached or detachable strip or band 10 may be a string, similar to a shoe lance, a self-sticky band, or a rubber band loop, of sufficiently length, that goes around the animal's leg on top of the bag-like slipper to secure a perfect fit (FIG. 2, 4B), and to hold the slipper not to fall off the foot.

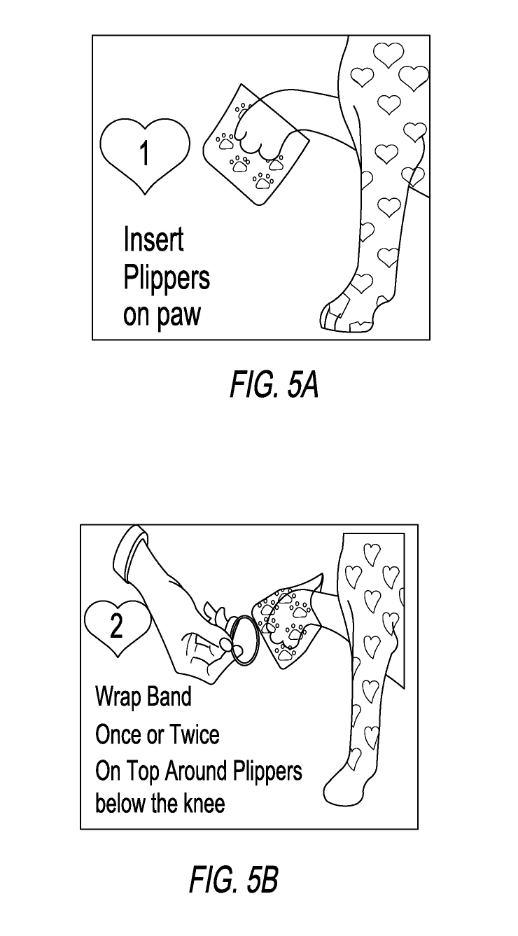

As shown in FIGS. 5A and 5B, the bag-like slipper can simply slip on the foot of an animal and be tied or secured tight around with band or the rubber loop.

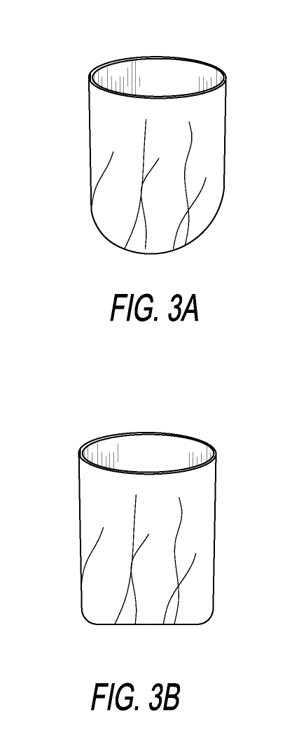

In another embodiment, the bottom rectangular corners may be rounded (FIG. 3A) with a round mold or print, and a round cut.

The bag-like slipper's tubular supply may first be preferably prefabricated by dipping it into a heat cured solution containing polyvinyl chloride (PVC) to seal off all seams and perforations. This solution may also comprise latex, rubber or polymer solution. Also, the slipper may be formed first by dipping a square shaped mold into the solution.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims. U.S. Pat. No. 5,495,828 and US Patent Application 2007/0175410 A1 are incorporated by reference to provide background and other related knowledge.

None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle.

The claims as filed are intended to be as comprehensive as possible, and NO subject matter is intentionally relinquished, dedicated, or abandoned.

What is claimed is:

1. Disposable animal slipper, comprising:
at least one bag-like sleeve, made of durable material, of sufficient size to contain an animal lower leg, having two ends and sealed sides, a cornered sealed bottom end and an unsealed aperture at the top end; and
a strip, unattached to said bag-like sleeve, of sufficient length and strength,
whereby when said bag-like sleeve is put on an animal foot, said strip is used to secure the sleeve on the foot so that it will not fall off the foot.

2. The disposable animal slipper of claim 1, wherein said strip is a self-sticky fiber that enables two open ends to hold together.

3. The disposable animal slipper of claim 1, wherein said strip is a rubber band loop.

4. The disposable animal slipper of claim 1, wherein said bag-like sleeve comprises plurality of durable layers of material.

5. The disposable animal slipper of claim 1, wherein said bag-like sleeve is made of poly uterine.

6. A method for making disposable animal slippers, comprising the actions of:
forming a tube using durable and disposable material;
cutting the tube into sufficient sizes; and
sealing one end and leaving the other end open.

7. The method of claim 6, wherein the sealing step is by heat.
